(19) United States
(12) Patent Application Publication
(10) Pub. No.: US 2020/0350733 A1
(43) Pub. Date: Nov. 5, 2020

(54) SHIELD FOR PREVENTING INTERFERENCE FROM ELECTRICAL CONNECTOR

(71) Applicant: GOOGLE LLC, Mountain View, CA (US)

(72) Inventors: Zhiping Yang, Saratoga, CA (US); Songping Wu, Mountain View, CA (US); Jordan Kestler, Pacifica, CA (US); Huan Liao, San Jose, CA (US)

(21) Appl. No.: 16/400,415

(22) Filed: May 1, 2019

(51) Int. Cl. H01R 13/6595; H01R 12/53; H01R 12/71; H01R 12/75

(52) U.S. Cl. CPC H01R 13/6595; H01R 12/53; H01R 2201/06; H01R 12/75; H01R 12/716

(57) ABSTRACT

An electrical connector can include a tongue, a shell, multiple pins, and a shield. The shell can enclose the tongue, and can define an aperture for receiving a plug. The multiple pins can extend along the tongue. The multiple pins can extend beyond the shell a first distance from a back portion of the shell. The back portion of the shell can be opposite from the aperture. The shield can extend from a back portion of the shell. The shield can include a first arm extending away from the back portion of the shell a second distance and a second arm extending from the first arm. The second distance can be greater than the first distance.

### TECHNICAL FIELD

This description relates to electrical connectors.

### BACKGROUND

Electrical connectors can transmit signals between electronic devices.

### SUMMARY

According to an example, an electrical connector can include a tongue, a shell, multiple pins, and a shield. The shell can enclose the tongue, and can define an aperture for receiving a plug. The multiple pins can extend along the tongue. The multiple pins can extend beyond the shell a first distance from a back portion of the shell. The back portion of the shell can be opposite from the aperture. The shield can extend from a back portion of the shell. The shield can include a first arm extending away from the back portion of the shell a second distance and a second arm extending from the first arm. The second distance can be greater than the first distance.

According to an example, a computing device can include at least one processor, a memory device comprising instructions for execution by the at least one processor, and a Universal Serial Bus (USB) Type-C receptacle interface configured to transfer data to and from the at least one processor. The USB Type-C receptacle interface can include a tongue, a shell, multiple pins, and a shield. The shell can enclose the tongue, and can define an aperture for receiving a USB Type-C plug. The multiple pins can extend along the tongue. The multiple pins can extend beyond the shell a first distance from a back portion of the shell. The back portion of the shell can be opposite from the aperture. At least one of the multiple pins can be electrically coupled to the at least one processor. The shield can extend from the back portion of the shell. The shield can include a first arm extending away from the back portion of the shell a second distance and a second arm extending from the first arm. The second distance can be greater than the first distance.

According to an example, a method of manufacturing a Universal Serial Bus (USB) Type-C receptacle interface can include enclosing a tongue with a shell, the shell defining an aperture for receiving a plug, the tongue comprising multiple pins extending beyond the shell a first distance from a back portion of the shell, the back portion of the shell being opposite from the aperture, attaching a shield to the back portion of the shell, the shield comprising a first arm and a second arm, the first arm being attached to the back portion of the shell and extending a second distance from the back portion of the shell, the second arm being attached to the first arm, attaching the shell to a printed circuit board, and attaching the second arm to the printed circuit board.

The details of one or more implementations are set forth in the accompa-nying drawings and the description below. Other features will be apparent from the description and drawings, and from the claims.

### BRIEF DESCRIPTION OF THE DRAWINGS

FIG. 1A is a front perspective view of an electrical connector without a shield according to an example implementation.

FIG. 1B is a rear perspective view of the electrical connector without the shield according to an example implementation.

FIG. 2A is a side perspective view of the electrical connector with the shield according to an example implementation.

FIG. 2B is a side cross-sectional view of the electrical connector with the shield according to an example implementation.

FIG. 2C is a top cutout view of the electrical connector with the shield according to an example implementation.

FIG. 3 is a top view of a printed circuit board (PCB) according to an example implementation.

FIG. 4 is a top view of the PCB according to another example implementation.

FIG. 5 is a top view of the PCB according to another example implementation.

FIG. 6 is a perspective view of a computing device including the electrical connector according to an example implementation.

FIG. 7 is a flowchart showing a method of manufacturing the electrical connector.

FIG. 8 shows an example of a computer device and a mobile computer device that can be used to implement the techniques described here.

### DETAILED DESCRIPTION

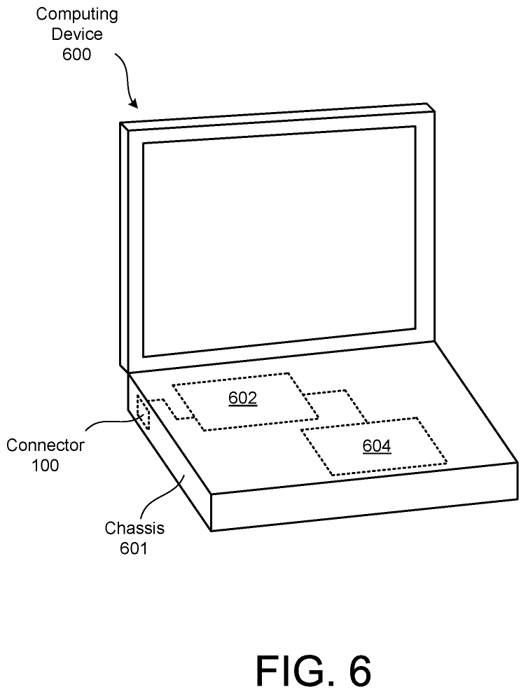

Electrical connectors can electrically couple two electronic devices, such as computing devices, together. The electrical coupling can enable the two computing devices to transmit signals to and from each other. The electrical connectors can include a receptacle or a plug. In some examples, each computing device, such as the computing device 600 shown in FIG. 6, can include a receptacle, and a cable with plugs at each of two ends can couple two computing devices upon insertion of the plugs into the receptacles.

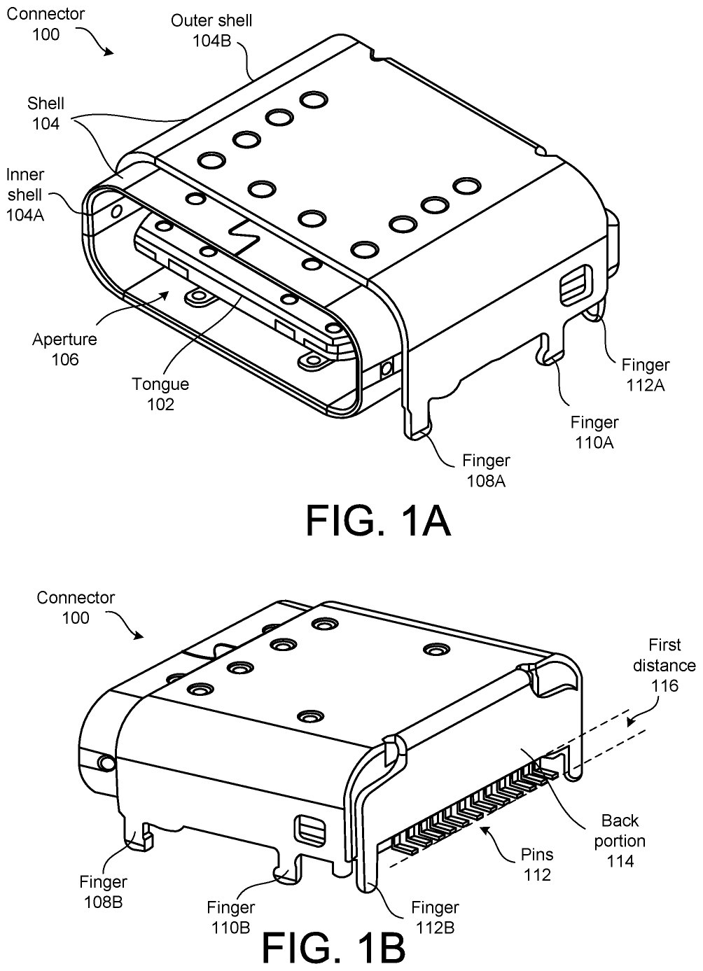

FIG. 1A is a front perspective view of an electrical connector 100 without a shield according to an example implementation. In some examples, the electrical connector 100 can include a receptacle, such as a Universal Serial Bus (USB) Type-C receptacle interface, or an internal connector such as an embedded DisplayPort (eDP) connector which connects a printed circuit board (PCB) to a display module, or a Mobile Industry Processor Interface (MIP) connector which connects the PCB board to a camera.

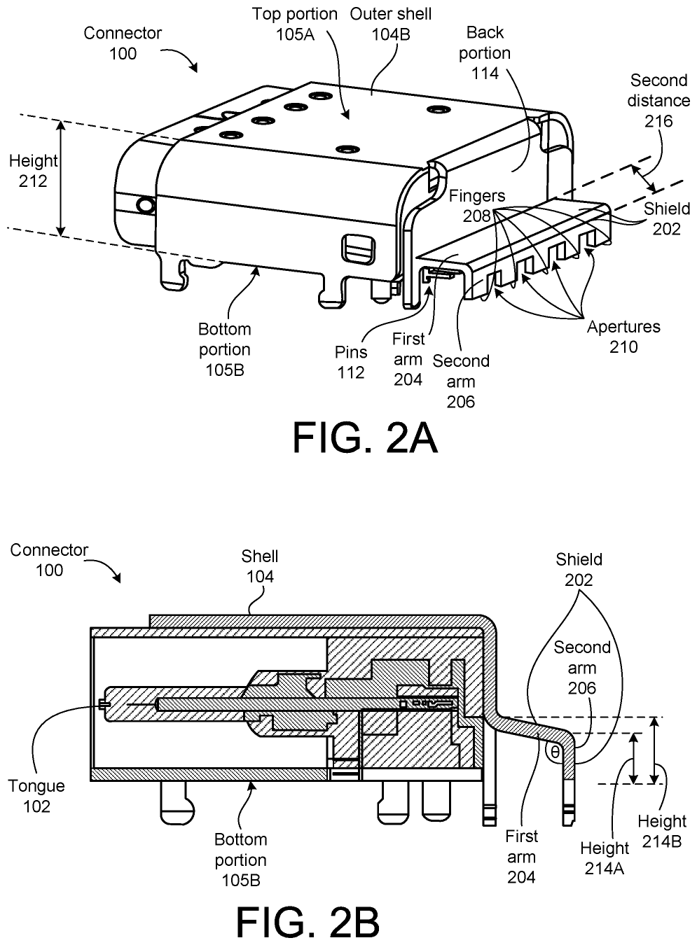

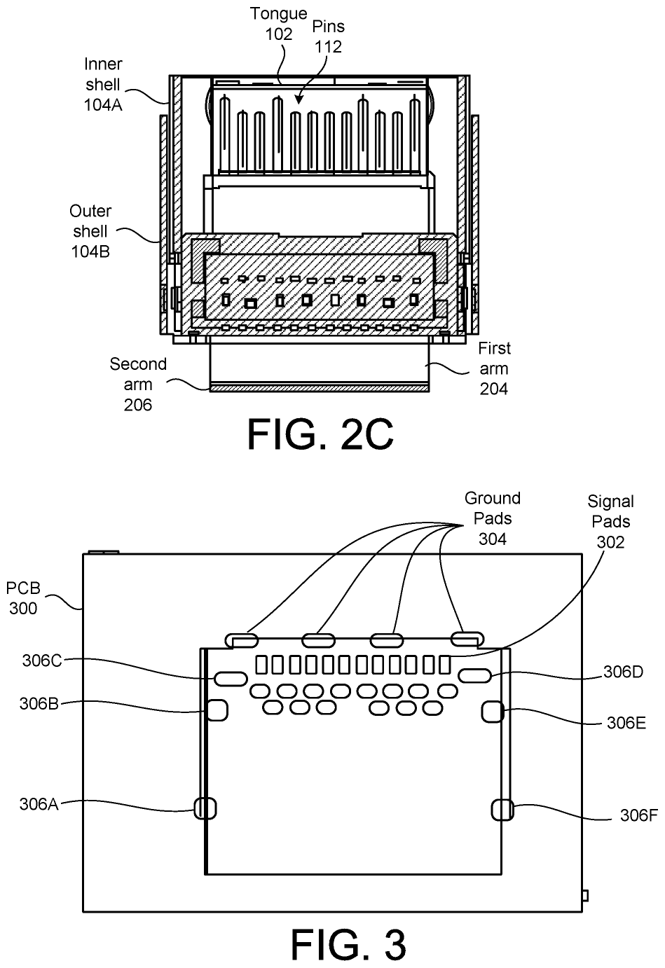

The electrical connector 100 can include a tongue 102. The tongue 102 can be received by an aperture in the plug that is inserted into the electrical connector 100. The electrical connector 100 can include multiple pins 112 (shown in FIGS. 1B and 2C). The pins 112 can extend along the tongue 102. The pins 112 can transmit electrical signals to and from the computing device 600 (shown in FIG. 6) through the electrical connector 100.

The electrical connector 100 can include a shell 104. The shell 104 can enclose the tongue 102. The shell 104 can define an aperture 106 at a front portion of the electrical connector 100. The aperture 106 can be configured and/or shaped to receive the plug, such as a USB Type-C plug. The shell 104 can be made of a conductive material, such as metal. The conductive material of the shell 104 can absorb and/or reduce electromagnetic radiation from the pins 112, reducing electromagnetic interference with electronic devices and/or wireless networks proximal to the electrical connector 100.

In some examples, the shell 104 can include an inner shell 104A and an outer shell 104B. The inner shell 104A can enclose the tongue 102. The outer shell 104B can enclose a portion of the inner shell 104A. In some examples, the outer shell 104B can include multiple fingers 108A, 108B, 110A, 110B, 112A, 112B (half of which are shown in FIG. 1B). The fingers 108A, 108B, 110A, 110B, 112A, 112B can secure the electrical connector 100 and/or shell 104 to a printed circuit board (PCB) 300 (shown in FIGS. 3, 4, and 5). In some examples, one or more of the fingers 108A, 108B, 110A, 110B, 112A, 112B can be coupled to a ground board in the PCB 300. The coupling of one or more of the fingers 108A, 108B, 110A, 110B, 112A, 112B to ground can ground the shell 104. The grounding of the shell 104 can enable the shell 104 to absorb electromagnetic radiation emitted by the pins 112, reducing interference by the pins 112 with wireless networks.

FIG. 1B is a rear perspective view of the electrical connector 100 without the shield according to an example implementation. As shown in FIG. 1B, the pins 112 extend beyond the shell 104. In some examples, the pins 112 extend beyond a back portion 114 of the shell 104 and/or outer shell 104B. The back portion 114 can be on an opposite end of the electrical connector 100 from the aperture 106 (shown in FIG. 1A). The pins 112 can extend under and/or beyond the shell 104 and/or outer shell 104B. The pins 112 extend a first distance 116 beyond the shell 104 and/or outer shell 104B.

Left unshielded, the pins 112 can emit electromagnetic radiation when carrying electronic signals between computing devices. This radiation can interfere with wireless communication, such as signals sent and received by Institute for Electrical and Electronics Engineers (IEEE) 802.11 Wireless Fidelity (“WiFi”) devices proximal to the connector 100.

The electromagnetic radiation emitted by the pins 112 can cause desense, or a degradation in sensitivity of WiFi devices. The WiFi specification has a maximum desense of three decibels (3 dB). Experiments in which the electrical connector 100 is a Universal Serial Bus (USB) Type-C receptacle interface have shown that transferring data received by the electrical connector 100 across the unshielded pins 112 can cause up to ten decibels (10 dB) of desense, violating the WiFi specification.

FIG. 2A is a side perspective view of the electrical connector 100 with the shield 202 according to an example implementation. The shield 202 can absorb electromagnetic radiation emitted by the pins 112, reducing desense in a wireless network. A connector height 212 of the electrical connector 100 can be considered a distance from an outer surface of a top portion 105A of the shell 104 and/or outer shell 104B to an outer surface of a bottom portion 105B of the shell 104 and/or outer shell 104B. The top portion 105A can be adjacent to the back portion 114. The bottom portion 105B can be adjacent to the back portion 114 and opposite from the top portion 105A. In some examples, the connector height 212, and/or distance from an outer surface of a top portion 105A of the shell 104 and/or outer shell 104B to an outer surface of a bottom portion 105B of the shell 104 and/or outer shell 104B, can be less than three millimeters (3 mm). The shield 202 can extend from the back portion 114 of the shell 104, and/or from the back portion 114 of the outer shell 104B.

The shield 202 can include a first arm 204 and a second arm 206. The first arm 204 and/or second arm 206 can comprise a conductive material, such as metal. The first arm 204 can extend from the back portion 114 of the shell 104 a second distance 216. The second distance 216 that the first arm 204 extends from the shell 104 can be greater than the first distance 116 that the pins 112 extend beyond the back portion 114 of the shell 104. The greater distance 216 that the first arm 204 extends from the shell 104 than the distance 116 that the pins 112 extend beyond the shell 104 can cause the first arm 204 to superpose and/or cover the pins 112. An air gap can be maintained between the pins 112 and the first arm 204, insulating the first arm 204 from the pins 112.

The shield 202 can include a second arm 206. The second arm 206 can extend from the first arm 204. The second arm 206 can extend from the first arm 204 to a printed circuit board (PCB) 300 (shown in FIGS. 3, 4, and 5). The second arm 206 can extend from the first arm 204 at an angle of, for example, between sixty degrees (60°) and ninety degrees (90°), inclusive. The shield 202 can be grounded and/or electrically coupled to the outer shell 104B. An air gap can be maintained between the pins 112 and the second arm 206, insulating the second arm 206, and the shield 202, from the pins 112. The shield 202 can partially surround the pins 112. By partially surrounding the pins 112, the shield 202 can absorb electromagnetic radiation emitted by the pins 112. The absorption of the electromagnetic radiation by the shield 202 can reduce interference with other electronic devices and/or wireless networks. Experiments in which the electrical connector 100 is a Universal Serial Bus (USB) Type-C receptacle interface have shown that with the shield 202, the desense cause by the pins 112 when the electrical connector is transmitting data is less than 2.6 dB, within the WiFi specification.

The second arm 206 can include multiple fingers 208. The fingers 208 can extend to the PCB 300. The fingers 208 can be electrically coupled to the PCB 300. In some examples, the fingers 208 can be electrically coupled to ground pads 304 (shown in FIGS. 3, 4, and 5) and/or ground nodes in the PCB 300, electrically coupling the second arm 206 to a ground node of the PCB 300. While five fingers 208 are shown in FIG. 2A, the second arm 206 can include any number of fingers.

The second arm 206 and/or fingers 208 can define apertures 210, such as at least one aperture. The fingers 208 can define the apertures 210 between the second arm 206 and the PCB 300. The apertures 210 can be spaces between the fingers 208. The apertures 210 can reduce the weight of the second arm 206, shield 202, and/or connector 100. While four apertures 210 are shown in FIG. 2A, the fingers 208 can define any number of apertures.

FIG. 2B is a side cross-sectional view of the electrical connector 100 with the shield 202 according to an example implementation. In some examples, the second arm 206 extends from the first arm 204 at an angle θ of between sixty degrees (60°) and ninety degrees (90°), inclusive. In this example, the tongue 102 extends through the aperture 106 defined by the shell 104.

In the example shown in FIG. 2B, the second arm 206 extends from the first arm 204 at a location that is a shield height 214A from the PCB 300 to which the connector 100 and/or second arm 206 are attached. In the example shown in FIG. 2B, the first arm 204 extends from the shell 104 at a location that is a shield height 214B from the bottom portion 105B of the connector 100 and/or shell 104, and/or from the PCB 300 to which the connector 100 and/or shell 104 are connected. In some examples, the shield height 214A, 214B, measured either from the location of attachment of the first arm 204 to the shell 104, or from the location of attachment of the second arm 206 to the first arm 204, to the PCB 300, is less than half the connector height 212 of the connector 100 and/or shell 104. In some examples, the shield height 214A and/or length of the second arm 206 from the PCB 300 can be less than two millimeters. The low shield height 214A, 214B of the shield 202, and/or lengths of the arms 204, 206, can reduce the cost and/or weight of the shield 202.

FIG. 2C is a top cutout view of the electrical connector 100 with the shield 202 according to an example implementation. As shown in FIG. 2C, the pins 112 extend along the tongue 102. In some examples, pins can extend along both sides of the tongue 102 in a symmetrical pattern about an axis of the tongue 102, so that if the connector 100, or the plug received by the connector 100, is rotated one hundred and eighty degrees) (180°), the electrical coupling of the pins 112 to corresponding pins in the plug will remain the same. The extension of the pins 112 can enable the pins 112 to contact, and/or couple to, the corresponding pins of the plug received by the connector 100.

In some examples, the pins 112 can correspond to the Universal Serial Bus (USB) Type-C protocol. In some examples, the pins 112 can include twelve pins on each side of the tongue 102. In some examples, the pins 112 can include a first ground pin, a first power pin, a configuration channel pin, a positive pin of a differential pair, a negative pin of the differential pair, a sideband pin, a second power pin, and a second ground pin. In some examples, the pins 112 can include a first ground pin, a positive pin of a first differential pair, a negative pin of the first differential pair, a first power pin, a configuration channel pin, a positive pin of a second differential pair, a negative pin of the second differential pair, a sideband pin, a second power pin, a negative pin of a third differential pair, a positive pin of the third differential pair, and a second ground pin.

FIG. 3 is a top view of the printed circuit board (PCB) 300 according to an example implementation. In some examples, the electrical connector 100 (not shown in FIG. 3) can be secured to the printed circuit board (PCB) 300. The PCB 300 can be included in a computing device, such as the computing device 600 shown in FIG. 6. The PCB 300 can include and/or define ground slots 306A, 306B, 306C, 306D, 306E, 306F surrounded by a conductive material such as metal. The ground slots 306A, 306B, 306C, 306D, 306E, 306F can secure the electrical connector 100 to the PCB 300, such as by the fingers 108A, 108B, 110A, 110B, 112A, 112B (not shown in FIG. 3) extending through the slots 306A, 306B, 306C, 306D, 306E, 306F, and/or the fingers 108A, 108B, 110A, 110B, 112A, 112B can be attached to the conductive material surrounding the slots 306A, 306B, 306C, 306D, 306E, 306F such as by soldering.

The PCB 300 can include signal pads 302. The signals pads 302 can be coupled to the pins 112. The signal pads 302 can be coupled to a processor 602 (shown in FIG. 6) in a computing device 600 (shown in FIG. 6) to which the PCB 300 is attached. The signal pads 302 can route electronic signals between the processor and the pins 112.

The PCB 300 can include ground pads 304. The ground pads 304 (which can also be considered ground nodes) can be coupled to a ground node of the computing device 600. The ground pads 304 can be coupled to the fingers 208 of the shield 202. The ground pads can be coupled to the fingers 208 by, for example, a plated through hold (PTH) pin or a surface mount technology (SMT) pin. The coupling of the fingers 208 to ground can ground the shield 202, enabling the shield 202 to absorb electromagnetic radiation emitted by the pins 112. Coupling the fingers 208 to the ground pads 304 can also cause the voltage at the shell 104 to be equal to the voltage at the PCB 300 ground plane. With no voltage differential between the shell 104 and the PCB 300 ground plane, no magnetic dipole will form, and electromagnetic fields will not radiate from the shell 104, which could otherwise cause interference and/or desense. While four ground pads 304 are shown in FIG. 3, this is merely an example. The PCB 300 can include any number of ground pads 304, and/or the number of ground pads 304 can correspond to the number of fingers 208 in the electrical connector 100.

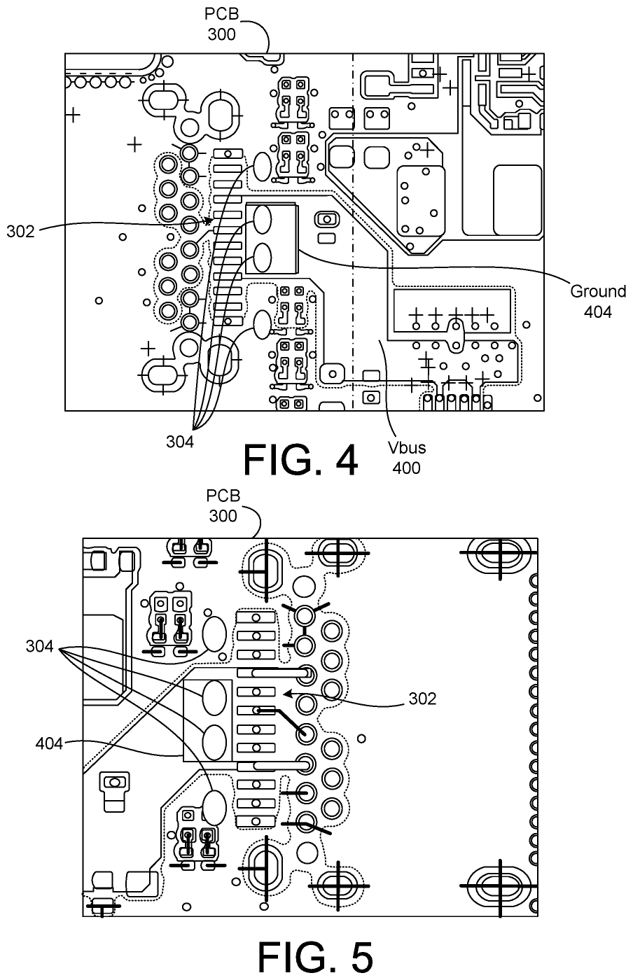

FIG. 4 is a top view of the PCB 300 according to another example implementation. In this example, two of the ground pads 304 are included in a ground box 404. The ground pads 304 can be adjacent to the signal pads 302. The ground box 404 can be included in a voltage bus (VBUS) 400. The ground box 404 can ground the shield 202 (not shown in FIG. 4).

FIG. 5 is a top view of the PCB 300 according to another example implementation. In this example, as in the example shown in FIG. 4, two of the ground pads 304, which can be adjacent to the signal pads 302, are included in a ground box 404. However, in this example, the ground box 404 is not included in a voltage bus.

FIG. 6 is a perspective view of a computing device 600 including the electrical connector 100 according to an example implementation. In this example, the connector 100 can be included in, and/or attached to, a chassis 601 of the computing device 600. Components of the computing device 600 can be mounted to the chassis 601. The chassis 601 can support components of the computing device 600, such as the at least one processor 602, a memory device 604, and the shell 104 (not labeled in FIG. 6) of the electrical connector 100. The electrical connector 100 can be coupled to at least one processor 602 of the computing device 600. The pins 112 of the electrical connector 100 can be coupled to the processor 602. The processor 602 can be coupled to the memory device 604 included in the computing device 600. The memory device 604 can comprise instructions for execution by the at least one processor 602. While the example of FIG. 6 shows the computing device 600 as a laptop computer, the electrical connector 100 can be coupled to and/or included in any type of computing device, such as a desktop or tower computer, a tablet computing device, a smartphone, a printer, a scanner, or a router, as non-limiting examples.

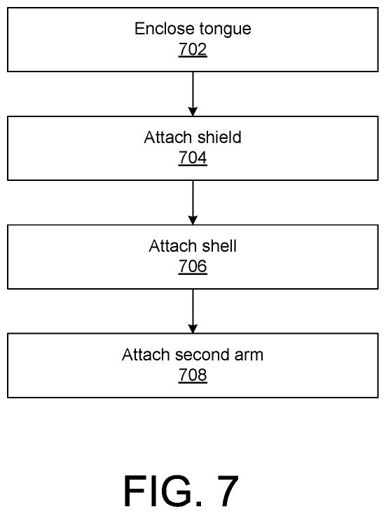

FIG. 7 is a flowchart showing a method of manufacturing an electrical connector 100. The electrical connector 100 can include, for example, a Universal Serial Bus (USB) Type-C receptacle interface.

The method can include enclosing a tongue 102 with a shell 104 (702). The shell 104 can define an aperture 106 for receiving a plug. The tongue 102 can comprise multiple pins 112 extending beyond the shell 104 a first distance 116 from a back portion 114 of the shell 104. The back portion 114 of the shell 104 can be opposite from the aperture 106.

The method can include attaching a shield 202 (704) to the back portion 114 of the shell 104. The shield 202 can include a first arm 204 and a second arm 206. The first arm 204 can be attached to the back portion 114 of the shell 104 and extend a second distance 216 from the back portion 114 of the shell 104. The second arm 206 can be attached to the first arm 204.

The method can include attaching the shell 104 (706) to a printed circuit board (PCB) 300.

The method can include attaching the second arm 206 (708) to the printed circuit board (PCB) 300.

According to an example, the method can further include electrically coupling the shell 104 to a ground node 304 of the printed circuit board (PCB) 300.

According to an example, the method can further include electrically coupling the second arm 206 to the ground node 304 of the printed circuit board 300.

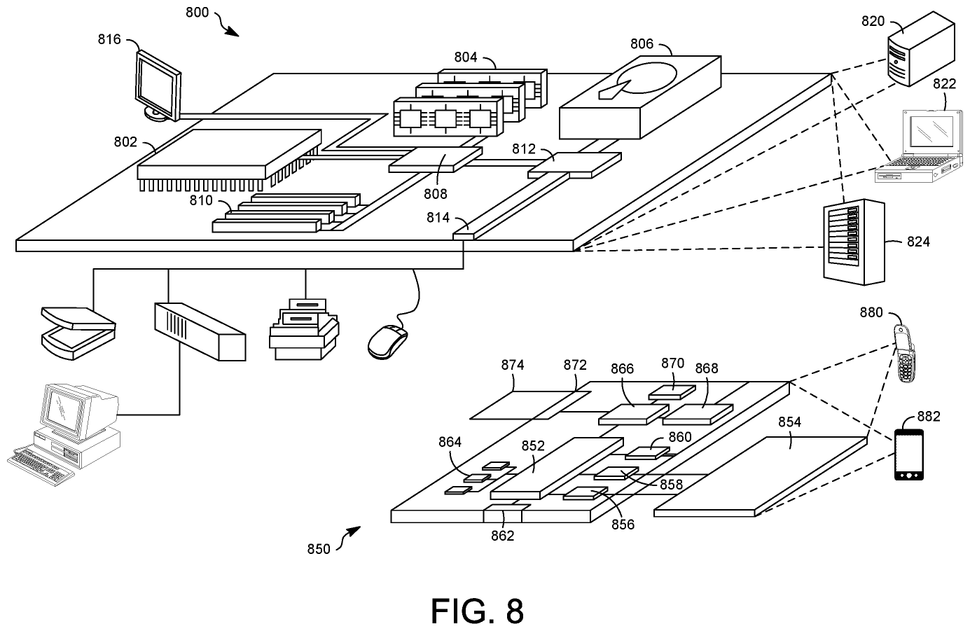

FIG. 8 shows an example of a generic computer device 800 and a generic mobile computer device 850, which may be used with the techniques described here. The electrical connector 100 can be included in the computer device 800 and/or mobile computer device 850, either of which can include features of the computing device 600 described above. Computing device 800 is intended to represent various forms of digital computers, such as laptops, desktops, tablets, workstations, personal digital assistants, televisions, servers, blade servers, mainframes, and other appropriate computing devices. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. The processor 802 can be a semiconductor-based processor. The memory 804 can be a semiconductor-based memory. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. An electrical connector comprising:
a tongue;
a shell enclosing the tongue, the shell defining an aperture for receiving a plug;
multiple pins extending along the tongue, the multiple pins extending beyond the shell a first distance from a back portion of the shell, the back portion of the shell being opposite from the aperture; and
a shield extending from a back portion of the shell, the shield including a first arm extending away from the back portion of the shell a second distance and a second arm extending from the first arm, the second distance being greater than the first distance, the shield extending from a first end portion of the back portion of the shell to a second end portion of the back portion of the shell.

2. The electrical connector of claim 1, wherein:
the shell is secured to a printed circuit board; and
the second arm extends from the first arm to the printed circuit board.

3. The electrical connector of claim 2, wherein the second arm defines at least one aperture between the second arm and the printed circuit board.

4. The electrical connector of claim 2, wherein the second arm defines four apertures between the second arm and the printed circuit board.

5. The electrical connector of claim 2, wherein the second arm comprises five fingers, each of the five fingers being coupled to the printed circuit board.

6. The electrical connector of claim 2, wherein the second arm is electrically coupled to a ground node of the printed circuit board.

7. The electrical connector of claim 1, wherein the first arm comprises a conductive material.

8. (canceled)

9. The electrical connector of claim 1, wherein a length of the second arm is less than two millimeters.

10. The electrical connector of claim 1, wherein:
the shell comprises a top portion and a bottom portion, the top portion being adjacent to the back portion, the bottom portion being adjacent to the back portion and opposite from the top portion; and
a distance from an outer surface of the top portion to an outer surface of the bottom portion is less than three millimeters.

11. The electrical connector of claim 1, wherein the multiple pins comprise:
a first ground pin;
a first power pin;
a configuration channel pin;
a positive pin of a differential pair;
a negative pin of the differential pair;
a sideband pin;
a second power pin; and
a second ground pin.

12. The electrical connector of claim 1, wherein the multiple pins comprise:
a first ground pin;
a positive pin of a first differential pair;
a negative pin of the first differential pair;
a first power pin;
a configuration channel pin;
a positive pin of a second differential pair;
a negative pin of the second differential pair;
a sideband pin;
a second power pin;
a negative pin of a third differential pair;
a positive pin of the third differential pair; and
a second ground pin.

13. A computing device comprising:
at least one processor;
a memory device comprising instructions for execution by the at least one processor; and
a Universal Serial Bus (USB) Type-C receptacle interface configured to transfer data to and from the at least one processor, the USB Type-C receptacle interface comprising:
a tongue;
a shell enclosing the tongue, the shell defining an aperture for receiving a USB Type-C plug;
multiple pins extending along the tongue, the multiple pins extending beyond the shell a first distance from a back portion of the shell, the back portion of the shell being opposite from the aperture, at least one of the multiple pins being electrically coupled to the at least one processor; and
a shield extending from the back portion of the shell, the shield including a first arm extending away from the back portion of the shell a second distance and a second arm extending from the first arm, the second distance being greater than the first distance,
wherein the first arm extends from the back portion at an angle of less than ninety degrees (90°).

14. The computing device of claim 13, further comprising a chassis supporting the at least one processor, the memory device, and the shell.

15. The computing device of claim 13, wherein:
the shell is secured to a printed circuit board; and
the second arm extends from the first arm to the printed circuit board.

16. The computing device of claim 15, wherein the second arm is electrically coupled to a ground node of the printed circuit board.

17. The computing device of claim 15, wherein the second arm comprises five fingers, each of the five fingers being electrically coupled to the printed circuit board.

18. A method of manufacturing a Universal Serial Bus (USB) Type-C receptacle interface, the method comprising:
enclosing a tongue with a shell, the shell defining an aperture for receiving a plug, the tongue comprising multiple pins extending beyond the shell a first distance from a back portion of the shell, the back portion of the shell being opposite from the aperture; and
attaching a shield to the back portion of the shell, the shield extending from a first end portion of the back portion of the shell to a second end portion of the back portion of the shell, the shield comprising a first arm and a second arm, the first arm being attached to the back portion of the shell and extending a second distance from the back portion of the shell, the first arm extending from the back portion at an angle of less than ninety degrees (90°), the second arm being attached to the first arm;
attaching the shell to a printed circuit board; and
attaching the second arm to the printed circuit board.

19. The method of claim 18, further comprising electrically coupling the shell to a ground node of the printed circuit board.

20. The method of claim 19, further comprising electrically coupling the second arm to the ground node of the printed circuit board.

21. The electrical connector of claim 1, wherein the first arm extends from the back portion at an angle of less than ninety degrees (90°).
